(19) United States
(12) Patent Application Publication
(10) Pub. No.: US 2005/0258560 A1
(43) Pub. Date: Nov. 24, 2005

(54) Method for producing an EVA sole material

(76) Inventors: Ching-Chin Chen, Taichung (TW); Shih-Kan Liang, Taichung Hsien (TW)

Correspondence Address: CHIN-CHING HSIEN, 235 CHUNG-HO BOX 8-24, TAIPEI HSIEN, TW

(21) Appl. No.: 10/851,958

(22) Filed: May 24, 2004

(51) Int. Cl. B29C 44/02

(52) U.S. Cl. 264/46.4

(57) ABSTRACT

A method for producing an EVA sole material comprises the steps of uniformly mixing EVA (ethylene-vinylacetate) material and foam material sufficiently as a mixture material; using at least one rollers rolling through the mixture material as a sheet; cutting the sheet into a plurality of sub-sheets; overlapping some of the plurality of sub-sheets to have a predetermined weight; placing the overlapping sub-sheets into a sealed space in a mold having a texture of a shoe; venting and vacuuming air within the space; foaming the sub-sheets in the mold; vacuuming the sub-sheets in the mold; transferring the sub-sheets through a transfer belt with different temperature stages of 75° C., 65° C., 55° C., 35° C. sequentially through a time period of about 40 minutes; wherein each temperature being retained another predetermined time period in the transfer belt; and checking and packing the produced sub-sheets.

### FIELD OF THE INVENTION

The present invention relates to sole material, and particular to a method for producing an EVA sole material, which has less steps and material can be saved so as to match the requirement of environmental protection.

### BACKGROUND OF THE INVENTION

One prior art method for producing an EVA sole material comprises the steps of:
Uniformly mixing EVA (ethylene-vinylacetate) material and foam material sufficiently as a mixture material;
Using at least one rollers rolling through the mixture material as a sheet;
Cutting the sheet into a plurality of sub-sheets; wherein each sub-sheet has a predetermined length;
Foaming the sub-sheets by oil pressure using a larger scale oil pressure machine;
Scraping the upper and lower layers of the foamed sub-sheets since the upper and lower layers will affect the quality of the material;
Cutting the sub-sheets obliquely according to the shape of a shoe;
Smoothing the edge of the sub-sheets;
Thermal pressing and then cooling the sub-sheets in a shoe mold;
Trimming the sub-sheets taking from the mold as a shoe sole material.

However, the abovementioned prior art has the following disadvantages. More material is wasted and the process is complicated. Moreover, it is known that the sub-sheets so produced are thick and thus the process of removing upper and lower layers is necessary. Only a part of sub-sheet is used. The sub-sheets including foaming material are foamed, but this will affect the quality of the EVA material. Such EVA material will affect the environment as the EVA material is burnt. Moreover, since the process is complicated, the working time is prolonged and thus cost is high.

The steps of smoothing, thermal pressing and trimming will cause the edges of the EVA sub-sheets are wide so as to affect the quality of the product.

To improve the defects in above-mentioned prior art, an improve method is disclosed by the inventor of the present invention. The method comprises the following steps.

Uniformly mixing EVA (ethylene-vinylacetate) material and foam material sufficiently as a mixture material;
Using at least one rollers rolling through the mixture material as a sheet;
Cutting the sheet into a plurality of sub-sheets; wherein each sub-sheet has a predetermined length;
Overlapping some of the plurality of sub-sheets to have a predetermined weight;
Foaming the sub-sheets by oil pressure using a small scale oil pressure machine;
Scraping the upper and lower layers of the foamed sub-sheets since the upper and lower layers will affect the quality of the material;
Cutting the sub-sheets to have desired sizes since the foamed EVA sub-sheets have sizes larger than those not foamed;
Smoothing the edge of the sub-sheets to have desired slopes;
Thermal pressing and then cooling the sub-sheets in a shoe mold;
Trimming the sub-sheets taking from the mold as a shoe sole material.

Above mentioned improved process can save material used than the prior art one. Moreover, the energy used is saved. However, the process is still complicated so as to limit the mass production ability. Moreover, two foaming processes are necessary. Thereby, it is necessary to cut the sub-sheets. More material is wasted. The steps of smoothing, thermal pressing and trimming will cause the edges of the EVA sub-sheets are wide so as to affect the quality of the product.

### SUMMARY OF THE INVENTION

Accordingly, the primary object of the present invention is to provide a method for producing an EVA sole material, wherein only one foaming process is necessary so that the material can be saved and the edge of the produced EVA sub-sheet is not wide.

Another object of the present invention is to provide method for producing an EVA sole material, wherein the method can achieve a yield ratio of 95 to 98%. The foaming time is about 6 to 7 minutes with a product of 200 pairs per mold per day. Thereby, the product is increased and only one mold is sufficient. Furthermore, the product is directly acquired after foaming. The process is reduced greatly and thus manpower and dynamic power can be reduced.

A further object of the present invention is to provide a method for producing an EVA sole material, wherein the products of the present invention have uniform sizes with clear textures and without wrinkles. Moreover, they have uniform hardness, no ventilating holes so as to have a beautiful appearance. Thus, the trimming process is neglected so that the problem about the waste in the material is resolved.

To achieve above objects, the present invention provides a method for producing an EVA sole material comprising the steps of: uniformly mixing EVA (ethylene-vinylacetate) material and foam material sufficiently as a mixture material; using at least one rollers rolling through the mixture material as a sheet; cutting the sheet into a plurality of sub-sheets; overlapping some of the plurality of sub-sheets to have a predetermined weight; placing the overlapping sub-sheets into a sealed space in a mold having a texture of a shoe; venting and vacuuming air within the space; foaming the sub-sheets in the mold; vacuuming the sub-sheets in the mold; transferring the sub-sheets through a transfer belt with different temperature stages of 75° C., 65° C., 55° C., 35° C. sequentially through a time period of 40 minutes; wherein each temperature being retained another predetermined time period in the transfer belt; and checking and packing the produced sub-sheets.

The various objects and advantages of the present invention will be more readily understood from the following detailed description when read in conjunction with the appended drawing.

### BRIEF DESCRIPTION OF THE DRAWINGS

FIG. 1 shows the processes about method for producing an EVA sole material of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

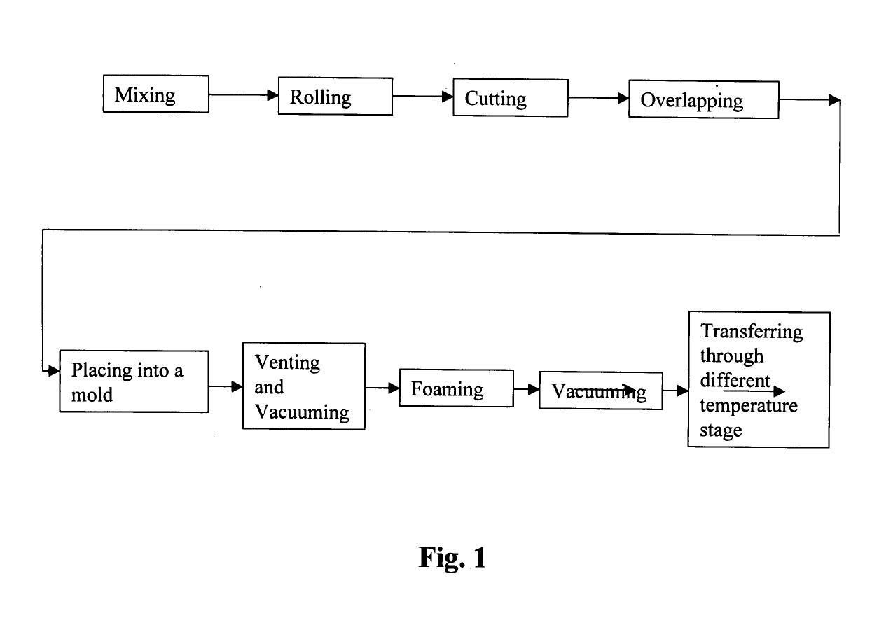

With reference to FIG. 1, the method for producing an EVA sole material of the present invention is illustrated. The method for producing an EVA sole material is performed at a temperature of 23° C. The processing comprising the steps of:
Uniformly mixing EVA (ethylene-vinylacetate) material and foam material sufficiently as a mixture material;
Using at least one rollers rolling through the mixture material as a sheet;
Cutting the sheet into a plurality of sub-sheets;
Overlapping some of the plurality of sub-sheets to have a predetermined weight;
Placing the overlapping sub-sheets into a sealed space in a mold having a texture of a shoe;
Venting and vacuuming air within the space;
Foaming the EVA sub-sheets in the mold;
Vacuuming the space of the mold;
Transferring the sub-sheets through a transfer belt with different temperature stages of 75° C., 65° C., 55° C., 35° C. sequentially through a time period of 40 minutes; wherein each temperature being retained another predetermined time period in the transfer belt;
Checking and packing the produced sub-sheets.

In the present invention, the processes of adding sulfur twice, cutting, and edging are unnecessary. Moreover, in the present invention, the foaming and texturing steps are performed by controlling of weight and vacuuming. When the EVA products are taken out from the mold, it has a uniform expansion coefficient and have clear texture. The products are also shaped in the transfer step with a plurality of predetermined temperatures each retaining a predetermined time period. Thus the size is precise.

Moreover, the yield ratio of the present invention can achieve a percent of 95 to 98%. The foaming time is about 6 to 7 minutes with a product of 200 pairs per mold per day. Thereby, the product is increased and only one mold is sufficient. Furthermore, the product is directly acquired after foaming. The process is reduced greatly and thus manpower and dynamic power can be reduced.

Moreover, the products of the present invention have uniform sizes with clear textures and without wrinkles. They have uniform hardness, no ventilating holes so as to have a beautiful appearance. Thus, the trimming process is neglected so that the problem about the waste in the material is resolved.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method for producing an EVA sole material comprising the steps of:
uniformly mixing EVA (ethylene-vinylacetate) material and foam material sufficiently as a mixture material;
using at least one rollers rolling through the mixture material as a sheet;
cutting the sheet into a plurality of sub-sheets;
overlapping some of the plurality of sub-sheets to have a predetermined weight;
placing the sub-sheets into a sealed space in a mold having a texture of a shoe;
venting and vacuuming air within the space;
foaming the sub-sheets in the mold;
vacuuming the space in the mold;
transferring the sub-sheets through a transfer belt with different temperature stages of 75° C., 65° C., 55° C., 35° C. sequentially through a first time period; wherein each of the four temperature is retained through another predetermined time period in the transfer belt; and
checking and packing the produced sub-sheets.

2. The method for producing an EVA sole material as claimed in claim 1, wherein the first time period is 40 minutes.
